(19) United States
(12) Patent Application Publication
(10) Pub. No.: US 2014/0301591 A1
(43) Pub. Date: Oct. 9, 2014

(54) EARPHONE

(71) Applicant: Bill Yang, Taipei City (TW)

(72) Inventor: Bill Yang, Taipei City (TW)

(73) Assignee: COTRON CORPORATION, Taipei City (TW)

(21) Appl. No.: 14/010,514

(22) Filed: Aug. 26, 2013

(30) Foreign Application Priority Data
Apr. 3, 2013 (TW) 102112159

(51) Int. Cl. H04R 1/10

(52) U.S. Cl. CPC H04R 1/1091
USPC 381/380

(57) ABSTRACT

An earphone including a housing, a speaker unit, and a gasket is provided. The speaker unit is disposed inside the housing and having a front cover. The gasket is attached between the front cover and the housing. A space inside the housing is divided into a front chamber and a rear chamber by the gasket and the speaker unit together. The front cover has a sound-output opening and a sound-leakage opening. The sound-output opening communicates the front chamber and a space inside the speaker unit. The sound-leakage opening communicates the rear chamber and a space inside the speaker unit.

### CROSS-REFERENCE TO RELATED APPLICATION

This application claims the priority benefit of Taiwan application serial no. 102112159, filed on Apr. 3, 2013. The entirety of the above-mentioned patent application is hereby incorporated by reference herein and made a part of this specification.

### FIELD OF THE INVENTION

This invention relates to an earphone, and more particularly, to an earphone that improves wearing comfort.

### Description of Related Art

With the rapid progress in technology, all electronic products have been developed towards light, handy, and miniaturized designs. People may use miniaturized electronic products at anytime and anywhere. In order to allow users to listen to the audio information provided by the electronic product without disturbing the other people around, an earphone has became a necessary accessory to the electronic product. Moreover, the earphone also provides listeners better audio transmission, so that the listeners can clearly hear and understand content of the audio information. In contrast to unclear audio transmission through the air, especially when the listeners are moving, for examples, doing exercises, driving, intensely moving around, or being in a noisy environment, the audio transmission of the earphone would still not be affected.

At present, a common earphone available in the market is reducing the size of an output-end of a housing and then putting silicone ear pads on. So the output-end can be placed more deeply into external ears of the users and adapted to the contour of the external ears because of elastic deformations of the silicone ear pads. This earphone uses the silicone ear pads to seal the external ears of the users, which isolates the external sound to enhance the sound quality. However, this earphone has a characteristic of airtight, as the users place the earphone into the external ears, the air between the eardrum and earphone will be compressed and cause the eardrum to receive a strong pressure, which results in a discomfort feeling. At the same time, air pressure causes a vibration film inside the earphone to deform or collapse, which leads to a reduction of sound quality and seriously affects the acoustic comfort.

### SUMMARY OF THE INVENTION

This invention provides an earphone to solve the earphone's known problems, the wearing discomfort and poor sound quality.

The earphone of this invention includes a housing, a speaker unit, and a gasket. The speaker unit is disposed inside the housing and having a front cover. The gasket is attached between the front cover and the housing. A space inside the housing is divided into a front chamber and a rear chamber by the gasket and the speaker unit together. The front cover has a sound-output opening and a sound-leakage opening. The sound-output opening communicates the front chamber and a space inside the speaker unit. The sound-leakage opening communicates the rear chamber and the space inside the speaker unit.

In an embodiment of this invention, the gasket is a closed ring and surrounding the sound-output opening, and the sound-leakage opening is located outside the gasket.

In an embodiment of this invention, the sound-output opening and the sound-leakage opening are located on the same plane.

In an embodiment of this invention, the sound-output opening and the sound-leakage opening are respectively located on planes of the front cover that are perpendicular to each other.

In an embodiment of this invention, the earphone further includes an acoustic damper disposed on the front cover and covering the sound-leakage opening.

In an embodiment of this invention, the earphone further includes an ear pad, which is assembled outside of the front chamber of the housing.

In an embodiment of this invention, the housing includes an air-leakage opening, which communicates the rear chamber and the external.

In an embodiment of this invention, a gap is kept between a sidewall of the speaker unit and the housing.

In an embodiment of this invention, the speaker unit is a moving-coil speaker unit.

Based on the above, the earphone of this invention uses the gasket between the housing and speaker unit to maintain an air channel, thus it can relieve the uncomfortable feeling and provide the best sound quality as the users wear the earphone.

To make the above features and advantages of this invention more comprehensible, several embodiments accompanied with drawings are described in detail as follows.

### BRIEF DESCRIPTION OF THE DRAWINGS

FIG. 1 is a schematic sectional view of an earphone according to an embodiment of this invention.

FIG. 2 is a schematic front view of a gasket and a speaker unit of the earphone of FIG. 1.

FIG. 3 is a schematic sectional view of an earphone according to another embodiment of this invention.

### DESCRIPTION OF THE EMBODIMENTS

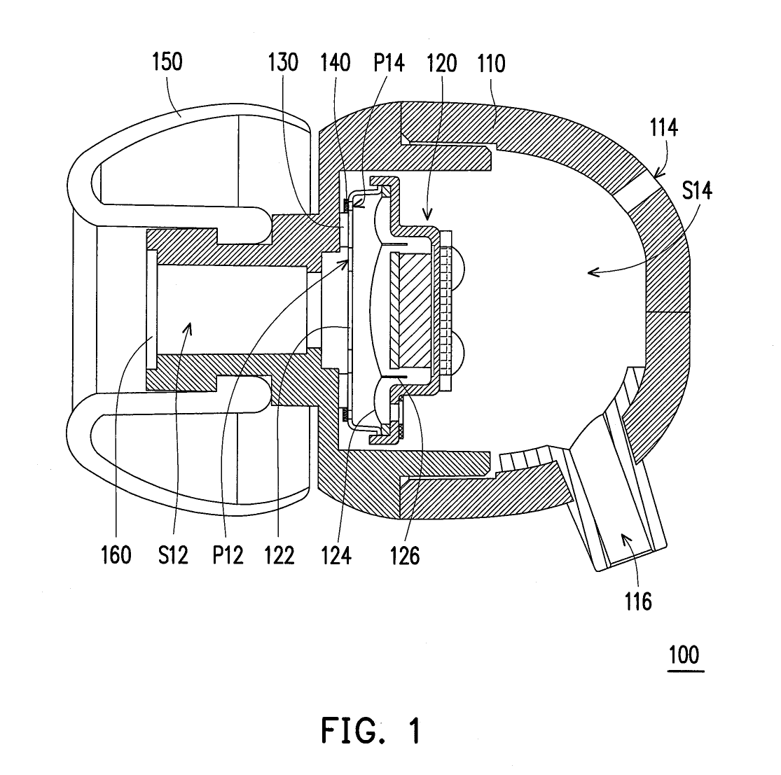

FIG. 1 is a schematic sectional view of an earphone according to an embodiment of this invention. Please refer to FIG. 1, the earphone 100 in this embodiment includes a housing 110, a speaker unit 120, and a gasket 130. The speaker unit 120 is disposed inside the housing 110 and having a front cover 122. The gasket 130 is attached between the front cover 122 and the housing 110, i.e. the gasket 130 directly contacts with the front cover 122 and the housing 110. A space inside the housing 130 is divided into a front chamber S12 and a rear chamber S14 by the gasket 130 and the speaker unit 120 together. The front cover 122 has a sound-output opening P12 and a sound-leakage opening P14. The sound-output opening P12 communicates the front chamber S12 and the space inside the speaker unit 120. The sound-leakage opening P14 communicates the rear chamber S14 and a space inside the speaker unit 120.

Between the front cover 122 of the speaker unit 120 and the housing 110, the presence of the gasket 130 can avoid the front chamber S12 and the rear chamber S14 of the housing 110 isolating from each other by the speaker unit 120. As the earphone 100 in this embodiment is placed into the external ears of the users, the air between the users' eardrum and the speaker unit 120 will orderly flow by the front chamber S12, the sound-output opening P12, the space inside the speaker unit 120, the sound-leakage opening P14, and the rear chamber S14, then finally flow to the external from the rear chamber S14. Hence, the users' eardrum would not feel uncomfortable because air is squeezed. Additionally, also the speaker unit 120 won't be deformed due to the air squeezing and cause sound distortion.

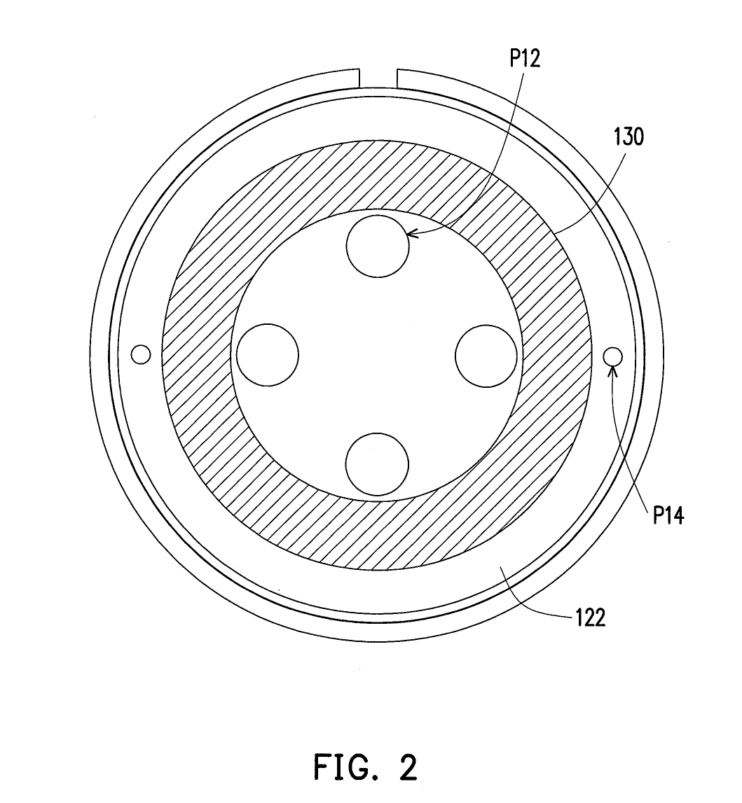

FIG. 2 is a schematic front view of a gasket and a speaker unit of the earphone of FIG. 1. Please refer to FIG. 1 and FIG. 2, the gasket 130 in this embodiment, the gasket 130 is a closed ring and surrounding the sound-output opening P12, and the sound-leakage opening P14 is located outside the gasket 130. The main function of sound-output opening P12 allows the speaker unit 120 to generate sounds which traveling through the front cover 122 and the front chamber S12 to the users' ears, and it can also be used as an air leakage channel when the earphone 100 is placed into users' ears. The gasket 130 in this embodiment is not only used to fix the related positions for the speaker unit 120 and the housing 110, but also to ensure that the air can only flow in the space between the front chamber S12 and the speaker unit 120 through the sound-output opening P12, which precisely controls the earphone 100 and provides the best perfect sound quality for the users. The gasket 130 can be made of soft materials, thus a joint surface of the front chamber S12 and the speaker unit 120 can still fit tightly together in the presence of the production tolerances. For instance, the gasket 130 can be foaming sponge, but the gasket 130 would be compacted in the assembly process; therefore, the gasket 130 itself does not allow the air pass through. Based on the above contents, the earphone 100 in this embodiment can provide the air leakage channel by additionally installing the sound-leakage opening P14 on the front cover 122 of the speaker unit 120; which is a simple design and remarkable effect.

In this embodiment, the sound-output opening P12 and the sound-leakage opening P14 are located on the same plane, i.e. located on the front cover 122 facing towards a front plane of the front chamber S12. In this embodiment, the numbers of the sound-output opening P12 and the sound-leakage opening P14 are four and two respectively as an example, but this invention is not limited the numbers of both. The areas of the sound-output opening P12 and the sound-leakage opening P14 can be adjusted in accordance with the design requirements. Please refer to FIG. 1, the earphone 100 in this embodiment further includes an acoustic damper 140, which is disposed on the front cover 122 and covering the sound-leakage opening P14. The acoustic damper 140 may be located outside the speaker unit 120, inside the speaker unit 120, or inside the sound-leakage unit P14; by selecting the pore density, materials, and thickness etc parameters of the acoustic damper 140 to adjust the sound quality of earphone 100. The earphone 100 in this embodiment further includes an ear pad 150, which is assembled outside of the front chamber S12 of the housing 110. The ear pad 150 is, in according to the contour of the external ears, then appropriately, elastically deformed to fit the ear canal of the external ears, and substantially isolating from the external sound. The housing 110 in this embodiment includes an air-leakage opening 114, which communicates the rear chamber S14 and the external. The housing 110 in this embodiment also includes a line hole 116, which allowing the wires (not shown) passed. A gap is kept between a sidewall of the speaker unit 120 and the housing 110 in this embodiment.

The speaker unit 120 in this embodiment is a moving-coil speaker unit, which however should not be constructed as a limitation to this invention. The moving-coil speaker unit is comprised mainly by a speaker vibration system (not shown) and a magnetic loop (not shown). The speaker vibration system, for example, includes a vibration film 124 and a coil 126. The magnetic loop, for example, includes a magnet and a polepiece. When the coil 126 induces the changes in the magnetic field generated because of the changes in electric signal, the magnetic field of the coil 126 interacts with the magnetic field of the magnet which causing the movement of the coil 126; thereby bringing the vibration film to vibrate and then generate sounds. The space inside the speaker unit 120 mentioned above means the space between the front cover 122 and the vibration film 124. The earphone 100 in this embodiment can further include a dust filter 160 disposed on a front-end of the housing 110.

Other embodiments are described to illustrate this invention in the following. It should be noted that the reference numerals and a part of the contents in the previous embodiment are used in the following embodiments, in which identical reference numerals indicate identical or similar components, and repeated description of the same technical contents is omitted. For a detailed description of the omitted parts, reference can be found in the previous embodiment, and no repeated description is contained in the following embodiments.

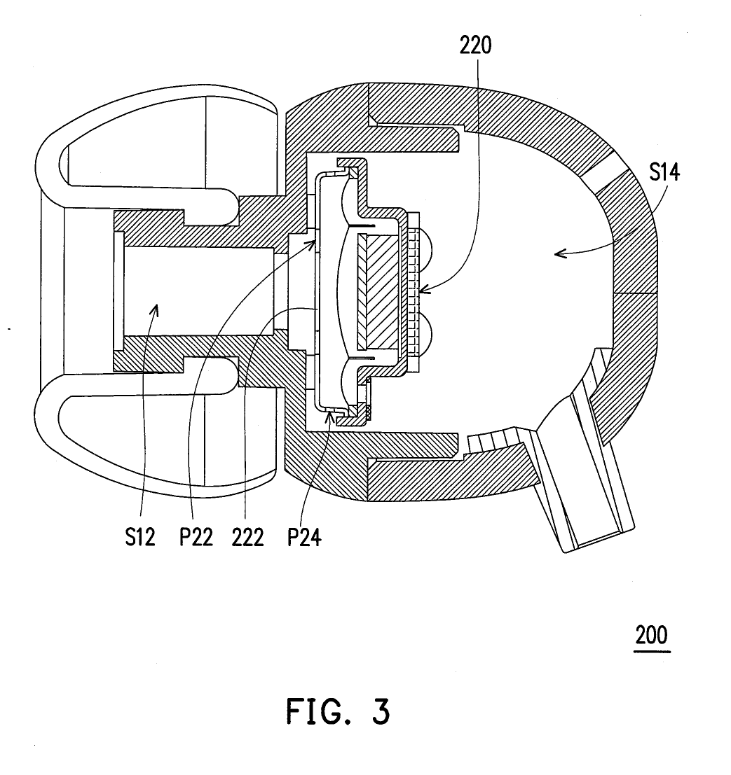

FIG. 3 is a schematic sectional view of an earphone according to another embodiment of this invention. Please refer to FIG. 3, the earphone 200 in this embodiment is similar to the earphone 100 in FIG. 1, one difference is the sound-output opening P22 and the sound-leakage opening P24 are respectively located on planes of the front cover 222 that are perpendicular to each other. For instance, the sound-output opening P22 is located on the front cover 222 facing towards the front plane of the front chamber S12, and the sound-leakage open P24 is located on a side of the front cover 222. As the earphone 200 in this embodiment is placed into the external ears of the users, the air between the users' eardrum and the speaker unit 220 will orderly flow by the front chamber S12, the sound-output opening P12, the speaker unit 220, the sound-leakage opening P14, and the rear chamber S14, then finally flow to the external from the rear chamber S14.

In conclusion of the above, the earphone of this invention uses the gasket maintaining the air channel between the housing and the speaker unit; therefore, when the users are wearing the earphone, the air between the users' eardrum and the earphone can be leaked through the air channel. Hence, it can provide the users with a comfortable wearing feel and ensure that the speaker unit provided the best sound quality under a normal atmosphere.

Although the this invention has been described with reference to the above embodiments, it will be apparent to one of the ordinary skill in the art that modifications to the described embodiments may be made without departing from the spirit of the invention. Accordingly, the scope of the invention is defined by the attached claims not by the above detailed descriptions.

What is claimed is:

1. An earphone, comprising:
a housing;
a speaker unit disposed inside the housing and having a front cover; and
a gasket attached between the front cover and the housing, wherein a space inside the housing is divided into a front chamber and a rear chamber by the gasket and the speaker unit together, the front cover has a sound-output opening and a sound-leakage opening, the sound-output opening communicates the front chamber and a space inside the speaker unit, and the sound-leakage opening communicates the rear chamber and the space inside the speaker unit.

2. The earphone as claimed in claim 1, wherein the gasket is a closed ring and surrounding the sound-output opening, and the sound-leakage opening is located outside the gasket.

3. The earphone as claimed in claim 1, wherein the sound-output opening and the sound-leakage opening are located on the same plane.

4. The earphone as claimed in claim 1, wherein the sound-output opening and the sound-leakage opening are respectively located on planes of the front cover that are perpendicular to each other.

5. The earphone as claimed in claim 1, further comprising an acoustic damper disposed on the front cover and covering the sound-leakage opening.

6. The earphone as claimed in claim 1, further comprising an ear pad, which is assembled outside the front chamber of the housing.

7. The earphone as claimed in claim 1, wherein the housing includes an air-leakage opening communicating the rear chamber and the external.

8. The earphone as claimed in claim 1, wherein a gap is kept between a sidewall of the speaker unit and the housing.

9. The earphone as claimed in claim 1, wherein the speaker unit is a moving-coil speaker unit.
